(19) United States
(12) Patent Application Publication
(10) Pub. No.: US 2013/0212939 A1
(43) Pub. Date: Aug. 22, 2013

(54) Automate Water Permeating Arrangement for Plant Container

(71) Applicant: Ai Li, Chengdu (CN)

(72) Inventor: Ai Li, Chengdu (CN)

(21) Appl. No.: 13/545,949

(22) Filed: Jul. 10, 2012

(30) Foreign Application Priority Data
Feb. 17, 2012 (CN) 201210042600.5

(51) Int. Cl. A01G 27/02

(52) U.S. Cl. 47/48.5

(57) ABSTRACT

An automate water permeating arrangement includes a water reservoir reserving a predetermined amount of water and a plurality of water permeating elements. Each of the water permeating elements has a water guiding end extended from the water reservoir and a water permeating end being selectively submerged into a particular area of a pot cavity of a plant container under a top surface level of a soil, wherein the water permeating elements are adapted for guiding the water from the water reservoir to the particular areas of the pot cavity and for gradually permeating the water at the water permeating ends of the water permeating elements so as to maintain and control a moisture level of the soil.

### BACKGROUND OF THE PRESENT INVENTION

1. Field of Invention

The present invention relates to a plant watering device, and more particular to an automate water permeating arrangement for a plant container, wherein the automate water permeating arrangement is adapted for incorporating with any plant container for gradually permeating water and/or nourishing liquid into a particular area within the plant container.

2. Description of Related Arts

Many people would like to keep the plants indoors for enhancing the aesthetic atmosphere. Some people even rent or buy the houseplants in the offices or workplaces to offer a better aesthetic value since the studies have shown that plants can help reduce stress, enhance employee attitudes, increase productivity, and improve air quality. In other words, workers are happier when offices have plants. On the other side, the plants must be watered periodically.

In the growing and maintenance of small plants and houseplants, water and/or nourishing liquid must be frequently provided to the root of the plant in correct amounts. Insufficient or excessive watering the plant may kill the plant, wherein water serves as the major transport medium to allow nutrients being carried from the soil to the plant cell through the root of the plant. However, when over watering the plant, it will force the air from the root of the plant to reduce the oxygen supply to the plant. In particular, there is no simple rule to guide the owner that how often the houseplants should be water. Some plants require relatively large amount of water to grow while some plants require relatively small amount of water to grow. Different types of soil are also considered as one of the factors to hold the moisture for the plant.

For some people, watering the plants is chore that they may forget all the times. Once the plant is dried, they trends to water the plant heavily. As it is mentioned above, insufficient or excessive watering the plant may kill the plant. Especially if the plant is rented from the plant service provider, the plant service provider must send a skilled person to take care of the plant frequently such as watering the plant and providing sufficient nourishing liquid to the plant. In other words, the skilled person must have sufficient knowledge of understanding all kinds of plants and how much water to be timely applied to the plant. Otherwise, the plant service provider will spend longer time to take care the sick plant being sent back from the renter.

Accordingly, a plant watering device is provided to water the plant frequently. For example, the plant watering device comprises a globe body for containing water and an elongated inserting tube extended from the globe body, wherein the inserting tube is sharp to be inserted into the soil for feeding the water from the globe body to the root of the plant. However, the plant watering device has several drawbacks.

Since the inserting tube must be inserted into the soil in order to feed the water thereinto, the roots of the plant may be accidentally damaged during the insertion. Once the globe body is emptied, the plant watering device must be removed from the plant container to refill the water and then the inserting tube must be re-inserted into the soil again. Repeatedly inserting the inserting tube into the soil will damage the roots of the plant seriously. In other words, even though sufficient water is provided, the plant will be killed while nutrients cannot be carried to the plant cell through the root of the plant.

Another drawback of the plant watering device is that the plant watering device can only supply water at one particular area around the inserting tube. In other words, after the inserting tube is inserted into the soil, the soil around the inserting tube will be moisturized. Therefore, only the root of the plant at the moisturized area will carry the nutrients to the plant. Other root portions of the plant will be dried. Therefore, the plant watering device cannot evenly supply water at all areas of the soil in the plant container.

In addition, the soil will continuously absorb the water from the plant watering device. In other words, the amount of water being watering in the plant does not depend on the moisture level of the soil. Once the soil is dried, the soil will rapidly absorb the water. Likewise, when the soil is wetted, the water will keep feeding to the soil continuously. Therefore, the plant watering device cannot control the moisture level of the soil precisely and will cause overwatering the plant.

### SUMMARY OF THE PRESENT INVENTION

The invention is advantageous in that it provides an automate water permeating arrangement which is adapted for incorporating with any plant container for gradually permeating water and/or nourishing liquid into a particular area within the plant container.

Another advantage of the invention is provide to an automate water permeating arrangement, wherein the water is gradually permeated into the soil in response to the moisture level of the soil so as to prevent overwatering the plant.

Another advantage of the invention is to provide an automate water permeating arrangement, which is a guidance to automatically water the plant with correct amount of water. In other words, the present invention will supply correct amount of water to different kinds of plants or different types of soils. Therefore, when the plants require relatively large amount of water to grow, the present invention will automatically feed more water to the soil. When the plants require relatively small amount of water to grow, the present invention will automatically feed less water to the soil.

Another advantage of the invention is to provide an automate water permeating arrangement, which can precisely control and maintain the moisture level of the soil. In other words, the present invention can incorporate with different types of soil to hold the moisture for the plant.

Another advantage of the invention is to provide an automate water permeating arrangement, which can selectively guide the water to different zones of the soil such that water can be evenly supplied to all areas of the soil within the plant container.

Another advantage of the invention is to provide an automate water permeating arrangement, which does not damage any portion, especially the roots, of the plant during watering operation.

Another advantage of the invention is to provide an automate water permeating arrangement, which facilities the user to refill the water without removing any part of the plant container or requiring any special watering tool.

Another advantage of the invention is to provide an automate water permeating arrangement, which does not require to alter the original planting structure or procedure of the plant, such that different kinds of plants can be potted in the present invention.

Another advantage of the invention is to provide an automate water permeating arrangement, wherein no expensive or complicated structure is required to employ in the present invention in order to achieve the above mentioned objects. Therefore, the present invention successfully provides an economic and efficient solution for supplying corrected amount of water into the plant and to prolong the watering period of the plant.

Additional advantages and features of the invention will become apparent from the description which follows, and may be realized by means of the instrumentalities and combinations particular point out in the appended claims.

According to the present invention, the foregoing and other objects and advantages are attained by an automate water permeating arrangement for a plant container, comprising a water reservoir for reserving a predetermined amount of water and a plurality of water permeating elements for guiding water into the plant container.

Each of the water permeating elements has a water guiding end extended from the water reservoir and a water permeating end being selectively submerged into a particular area of a pot cavity of a plant container under a top surface level of a soil, wherein the water permeating elements are adapted for guiding the water from the water reservoir to the particular areas of the pot cavity and for gradually permeating the water at the water permeating ends of the water permeating elements so as to maintain and control a moisture level of the soil.

In accordance with another aspect of the invention, the present invention comprises an automate water permeating arrangement for two or more plant containers, wherein the automate water permeating arrangement comprises a water reservoir for reserving a predetermined amount of water and a plurality of water permeating elements for guiding the water into the plant containers respectively.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of an automate water permeating arrangement according to a preferred embodiment of the present invention.

FIG. 2 is a sectional view of the automate water permeating arrangement for a plant container according to the above preferred embodiment of the present invention.

FIG. 3 is an alternative mode of the automate water permeating arrangement for two or more plant containers according to the above preferred embodiment of the present invention.

FIG. 4 is a sectional view of an alternative mode of an automate water permeating arrangement according to the above preferred embodiment of the present invention.

FIG. 5A is a sectional view of an automate water permeating arrangement according to a second preferred embodiment of the present invention.

FIG. 5B is a bottom view of the automate water permeating arrangement for plant containers according to a second preferred embodiment of the present invention.

FIG. 6 is a sectional view of an automate water permeating arrangement according to a third preferred embodiment of the present invention.

### DETAILED DESCRIPTION OF THE PREFERRED EMBODIMENT

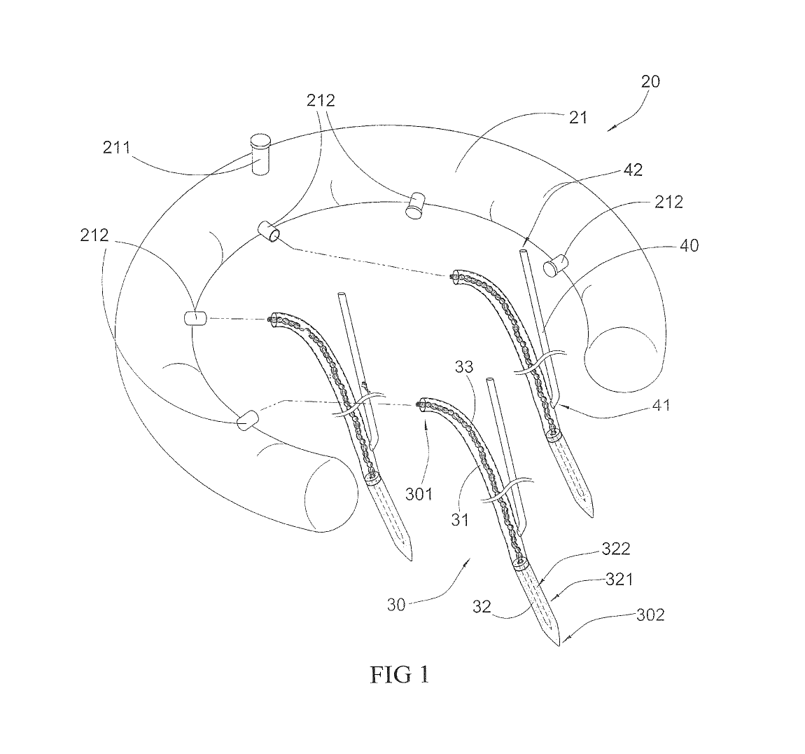

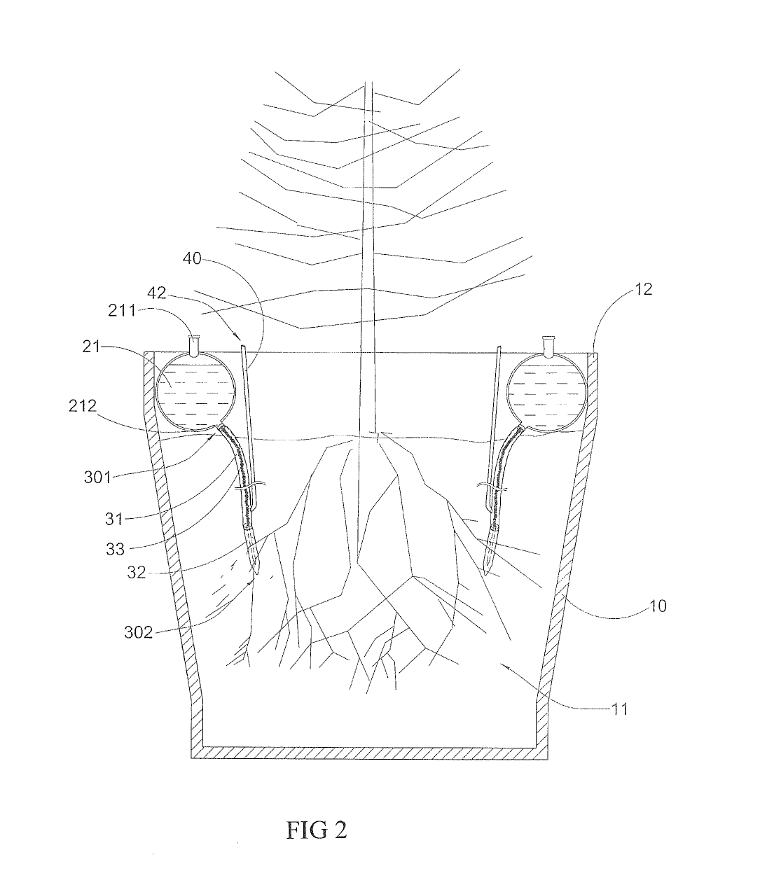

Referring to FIGS. 1 and 2 of the drawings, an automate water permeating arrangement for one or more plant containers 10 according to a preferred embodiment of the present invention is illustrated, wherein the plant container is a conventional plant pot in which flowers and other plants are cultivated. In particular, the roots of the plant are firmed within the plant container by soil.

The pot body 10 has a pot cavity 11 for containing the soil and the root of the plant and a rim 12 defining at a top opening of the pot cavity 11 to allow the plant to grow. Accordingly, the roots of the plant are retained within the pot cavity 11 of the pot body 10 by the soil.

The automate water permeating arrangement comprises a water reservoir 20 is arranged for reserving a predetermined amount of water, and a plurality of water permeating elements 30. Each of the water permeating elements 30 has a water guiding end 301 extended from the water reservoir 20 and a water permeating end 302 being selectively submerged into a particular area of the pot cavity 11.

Accordingly, the water permeating elements 30 are adapted for guiding the water from the water reservoir 20 to the particular areas of the pot cavity 11 and for gradually permeating the water at the water permeating ends 302 of the water permeating elements 30 so as to maintain and control a moisture level of the soil. In other words, the water permeating ends 302 of the water permeating elements 30 are located at different areas of the pot cavity 11 to permeate the water thereinto so as to evenly supply water at all areas of the pot cavity 11 to the roots of the plant.

As shown in FIG. 1, the water reservoir 20 comprises a water bladder 21, preferably having a C-shape, disposed on the top surface level of the soil within the pot cavity 11, such that the water within the water reservoir 20 is guided to flow to the water permeating elements 30 by means of water pressure.

It is worth mentioning that the water bladder 21 has a shape as desired, for example C-shape, D-shape, O-shape and the like, preferably C-shape. The water bladder 21 further comprises a plurality of water bladder units, wherein the plurality of water bladder units is communicatedly connected with each other in order to form the water bladder 21. Each of the water bladder units of the water bladder 21 may be a separated mini-water bladder respectively such that each of the water bladder units is coupled with one or more water permeating elements 30 provided therein to guide the water of the water bladder units of the water bladder 21 flowing into the soil of the pot cavity 11.

The water bladder 21 has a water inlet 211 adapted for being filled water in the water bladder 21, wherein the water guiding ends 301 of the water permeating elements 30 are spacedly extended from an inner wall of the water bladder 21. Therefore, when the water bladder 21 is disposed on the top surface level of the soil, the water permeating elements 30 will be hidden within the water bladder 21.

The water bladder 21, which is disposed on the top surface level of the soil, facilities the user to refill the water without removing any part of the plant container or requiring any special watering tool. The user is able to fill up the water in the water bladder 21 by a bottle of water. It is worth mentioning that nourishing liquid can also be added into the water bladder 21 such that the nourishing liquid will be transported to the soil through the water permeating elements 30.

The water bladder 21 further has a plurality of water outlets 212 spacedly formed at the inner wall thereof for the water guiding ends 301 of the water permeating elements 30 communicating with the water bladder 21. In particular, the water guiding ends 301 of the water permeating elements 30 are detachably coupled with the water outlets 212. In other words, the water permeating elements 22 not only are hidden within the pot cavity 11 and are protected by the pot body 10 but also are selectively adjusted the number of water permeating elements 22 being used. For a larger size pot body 10 or the plant requires relatively high amount of water, more water permeating elements 30 can be used to couple with the water bladder 21. It is worth mentioning that the unused water outlet 212 can be closed for preventing any water leakage of the water bladder 21. Preferably, a sealing ring is provided around the outer circumferential surface of the water guiding end 201 of the water permeating element 22 to sealedly and detachably couple the water guiding end 201 of the water permeating element 22 at the water outlet 211 for preventing water leakage.

Alternatively, the water bladder 21 is made of soft material having flexibility, wherein when the water bladder 21 has no water therein, the water bladder 21 is at a folded position. At this time, the water bladder 21 has no air or a little of air therein, wherein when the water bladder 21 is waterflooded via the water inlet 211 of the water bladder 21, the water bladder 21 is continuously expanded by the water from the water resource. Therefore, when the water bladder 21 is full of water filled, the water bladder 21 is at an unfolded position.

Alternatively, the water bladder 21 is made of rigid material and has a relatively bigger water inlet 211 provided in the top portion. When the water bladder 21 is waterflooded via the water inlet 211 of the water bladder 21, the cross-section of the water flow from the water resource is smaller than the cross-section of the water inlet 211 of the water bladder 21 such that the air of the water bladder 21 may be removed via the water inlet 211. Preferably, the water bladder 21 comprises a bladder cover provided thereat for covering the water inlet 211, and the bladder cover has an inlet opening and an outlet opening, wherein the inlet opening is adapted for flowing the water from the water resource to the water bladder 21, and the outlet opening is adapted for removing the air of the water bladder 21. More preferably, the automate water permeating arrangement comprises an inlet water pipe provided at the bladder cover for communicatedly connecting to the water bladder 21 and an air exhausting duct provided at the bladder cover for removing the air of the water bladder 21.

As shown in FIGS. 1 and 2, each of the water permeating elements 30 comprises a flexible water tube 31 extended from the water reservoir 20 and a water permeating head 32 extended from the flexible water tube 31 to the particular area of the pot cavity 11.

Accordingly, the flexible water tube 31 is made of water-sealed material such as plastic or rubber and has a predetermined flexibility that the flexible water tube 31 can be bent at any desired shape. The water guiding end 301 of the water permeating element 30 is defined at one end of the flexible water tube 31 such that the corresponding end of the flexible water tube 31 is operatively coupled with the water reservoir 20 at one of the water outlets 212 thereof. In addition, the length of the flexible water tube 31 can be selected and replaced in order to locate the water permeating head 32 at the desired location of the pot cavity 11.

The water permeating head 32 is coupled with the flexible water tube 31 end-to- end, wherein the flexible water tube 31 is arranged to be adjustably turned to selectively locate the water permeating head 32 at the particular area of the pot cavity 11. In other words, the water permeating head 32 can be selectively submerged into the pot cavity 11 for gradually permeating the water to the soil. In addition, the water permeating head 32 is detachably coupled with the flexible water tube 31, such that the user is able to replace or change one of the water permeating head 32 and the flexible water tube 31 in case of water leakage or broken part.

As shown in FIGS. 1 and 2, each of the water permeating head 32 is made of water permeating material such as ceramic and is formed in an elongated structure. The water permeating head 32 has a plurality of water permeating pores 321 for gradually permeating the water into the pot cavity 11 in response to the water content of the soil. In addition, the water permeating head 32 has a tubular structure defining a closed end, an opened end, and a water channel 322 extended between the closed end and the opened end. The water permeating head 32 will absorb the water until the water content of the water permeating head 32 is saturated.

Accordingly, the opened end of the water permeating head 32 is coupled at the flexible water tube 31 such that the water is guided to pass into the water channel 322 of the water permeating head 32 and is then gradually permeated to the soil through the water permeating pores 321. The closed end of the water permeating head 32 forms a tapered end thereof for enabling the water permeating head 32 being inserted into the soil within the pot body 10.

In particular, when the water content of the water permeating head 32 is lower than the water content of the soil, the water permeating head 32 is arranged for gradually permeating the water to the soil through the water permeating pores 322. When the water content of the water permeating head 32 is higher than a water content of the soil, the water permeating head 32 is arranged for stop permeating the water into said soil. It is worth mentioning that the water content of soil depends on how much water taken by the plant. Therefore, when the plant requires more water to grow, the water content of the soil will be reduced rapidly. On the other hand, the water permeating head 32 will permeate the water to maintain the water content of the soil.

Therefore, the water permeating head 32 will maintain the equilibrium of the water content between the water permeating head 32 and the soil to precisely maintain the control and maintain the moisture level of the soil. It is worth mentioning that when the water content of the soil is lower than the water content of the water permeating head 32, the water will be permeated through the water permeating head 32 to the soil by the water pressure. Once the equilibrium thereof is reached, i.e. the water content of the soil is the same as the water content of the water permeating head 32, the water will stop being permeated into the soil. Therefore, the water permeating head 32 can be incorporated with different kinds of soils. In addition, the correct amount of water will be supplied to the plant in responsive to the water content of the soil to prevent overwatering the plant.

The water permeating element 30 further comprises a water guiding element 33 received in the flexible water tube 31 to guide the water from the water reservoir 20 to the water permeating head 32. Accordingly, the water guiding element 33 is made of water permeating material such as cotton threads and is formed in an elongated structure. Therefore, water from the water reservoir 20 is guided to pass along the flexible water tube 31 via the water guiding element 33 toward the water permeating head 32.

The automate water permeating arrangement of the present invention further comprises a plurality of air venting ducts 40 operatively coupled with the water permeating elements 30. As it is mentioned above, the water is guided to pass through the water permeating elements 30 by means of water pressure at the water reservoir 20. When air is trapped within the water permeating element 30, the water will be blocked to pass therethrough. The air venting ducts 40 are arranged to remove the air within the water permeating elements 30.

As shown in FIGS. 1 and 2, each of the air venting ducts 40 is made of flexible and waterproof material such as plastic or rubber adapted to be submerged into the pot cavity 11 at any particular area thereof. The air venting ducts 40 are coupled with the flexible water tubes 31 respectively for releasing the air within the flexible water tubes 31 when the water is guided to the water permeating heads 32.

Each of the air venting ducts 40 has a lower end 41 coupled with the respective flexible water tube 31 at a position close to the water permeating head 32, and an upper end 42 extended upwardly above the top surface level of the soil. Preferably, the lower end 41 of the air venting duct 40 is upwardly extended from the flexible water tube 31. Therefore, when the water flows from the flexible water tube 31 to the water permeating head 32, the air within the flexible water tube 31 is also pushed toward the water permeating head 32. The air will be released from the flexible water tube 31 to the air venting tube 40 before entering into the water permeating head 32. Preferably, the lower end 41 of the air venting tube 40 is linked to the flexible water tube 31 with a distance of 0.5 cm away from the water permeating head 32 for ensuring the air being releasing out of the flexible water tube 31 before the air enters into the water permeating head 32.

The upper end 422 of each of the air venting tubes 40 is extended upwardly above the top surface level of the soil within the pot cavity 11. Preferably, the upper end 42 of the air venting tube 40 is retained at the top side of the top rim 12 of the pot body 10 at the inner side thereof. Therefore, no blocking element, such as water in the water reservoir 20 or soil particle within the pot cavity 11, will be accidentally stuck at the upper end 42 of the air venting tube 40 for blocking the air being released through the air venting tube 40. Preferably, once the air within the flexible water tube 31 is released through the respective air venting tube 40, the upper end 42 of the air venting tube 40 should be closed, such as by a stopper. When the water reservoir 20 is empty, air may enter into the flexible water tube 31 again. The upper end 42 of the air venting tube 40 will be re-opened to let the air releasing out of the flexible water tube 31.

In order to use the present invention, the user is able to pot the plant with the pot body 10 in the conventional way that the soil can be firstly put into the bottom portion of the pot cavity 11. At the same time, the water permeating head 32 of one of the water permeating elements 30 can be placed at the bottom portion of the soil. When keeping putting the soil into the pot cavity 11, the water permeating heads 32 of the water permeating elements 30 can be selectively placed at different areas of the pot cavity 11 and at different levels of the soil therewithin. Therefore, after filling the water and/or the nourishing liquid into the water reservoir 20 and placing the water reservoir 20 on top of the top surface level of the soil, the water permeating elements 30 will selectively guide the water to different zones of the soil such that water can be evenly supplied to all areas of the soil within the plant container.

Accordingly, since the water permeating heads 32 of the water permeating elements 30 are pre-located within different areas of the pot cavity 11, the user does not require removing the water permeating elements 30 to water the plant such that there is no damage for the roots of the plant. It is appreciated that the water permeating heads 32 can be inserted into the soil such that the water permeating elements 30 can located within different areas of the pot cavity 11 after the plant is pot in the pot body 10.

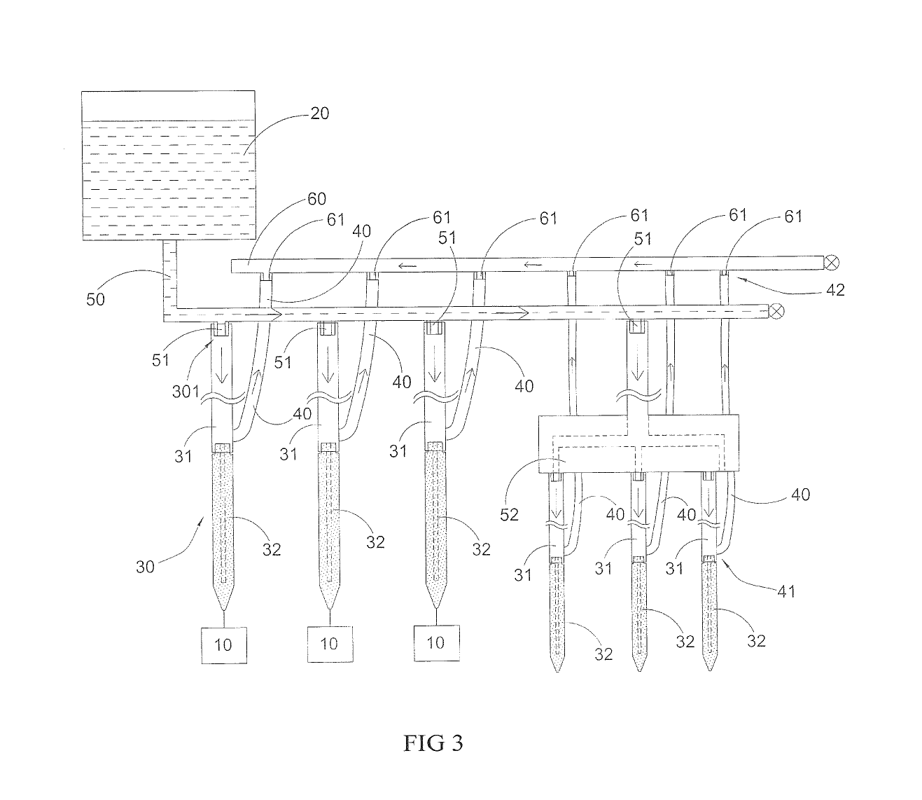

As shown in FIG. 3, a modification of the automate water permeating arrangement is illustrated for planting more than two plants at different plant containers at the same time. As shown in FIG. 3, the automate water permeating arrangement further comprises a flexible water guiding link 50 extended from the water reservoir 20 to the water permeating elements 30 to guide the water flowing from the water reservoir 20 to each of the water permeating elements 30. In particular, the water guiding link 50 is a tubular member defining an opened end and a closed end. The opened end of the water guiding link 50 is operatively linked to the water outlet 212 of the water reservoir 20. The closed end of the water guiding link 50 is preferably closed by a stopper to prevent water being leaked out from the water guiding link 50 when water is guided to each of the water permeating elements 30. Accordingly, the water reservoir 20 forms as a water tank for supplying water to different plant containers via the water permeating elements 30. The water outlet 212 of the water reservoir 20 is provided at the bottom portion thereof. It is worth mentioning that the water reservoir 20 is preferably located away from the plant containers and is positioned 1.5 meters above the ground level for ensuring the water flowing to each of the water permeating elements 30 by the water pressure.

Accordingly, the water guiding ends 301 of the water permeating elements 32 are spacedly extended from the water guiding link 50 between the closed and opened ends for guiding the water from the water reservoir 20 to the water permeating elements through the water guiding link 50. Preferably, the water guiding link 50 has a plurality of water passages 51 spacedly provided between the closed and opened ends to detachably and sealedly couple with the water guiding ends 301 of the water permeating elements 32. In other words, the flexible water tubes 31 are detachably coupled with the water passages 51 of the water guiding link 50. Therefore, the water guiding link 50 forms a bridge from water reservoir 20 to the plant containers to guide the water flowing thereto.

The water guiding link 50 further comprises at least a water splitting joint 52 detachably coupled one of the water passages 51 with two or more water permeating elements 32. Accordingly, the water splitting joint 52 has one water splitting inlet detachably coupled the water passage 51 and two or more water splitting outlets detachably coupled with two or more water permeating elements 32. In particular, the flexible water tubes 31 are detachably coupled with the water splitting outlets water splitting joint 52 to communicatively link to the water passages 51 of the water guiding link 50. In other words, when two or more water permeating elements 30 are required for watering the plant in the plant container, the water splitting joint 52 can be used as an adapter to allow two or more water permeating elements 32 being inserted into the pot cavity 11.

In order to extend the water coverage of the automate water permeating arrangement, two or more water guiding links 50 can be coupled together end-to-end for extending the water supplying distance. Accordingly, the opened end of the first water guiding link 50 can be operatively coupled with the water reservoir 20 while the closed end of the first water guiding link 50 is opened by detaching the stopper thereat to operatively couple with the opened end of the second water guiding link 50. Therefore, the water in the water reservoir 20 is guided to flow along the first and second water guiding links 50 to water the plants at different plant containers via the water permeating elements 30.

The automate water permeating arrangement further comprises an air guiding link 60 to guide the air releasing from the water permeating elements 30 through the air venting ducts 40. In particular, the air guiding link 60 is a tubular member defining an opened end and a closed end. The opened end of the water guiding link 50 is extended out of the plant containers for releasing air to the ambient area. The closed end of the air guiding link 60 is preferably closed by an air stopper to prevent air entering into the air guiding link 60 when air is released at the opened end of the air guiding link 60.

Accordingly, the lower end 41 of each of the air venting ducts 40 is coupled with the respective flexible water tube 31 at a position close to the water permeating head 32. The upper ends 42 of the air venting ducts 40 are spacedly and detachably coupled with the air guiding link 60 between the closed and opened ends thereof, such that the air within the flexible water tubes 31 is collected by the air guiding link 60. It is worth mentioning that the air from different air venting ducts 40 is collected by the air guiding link 60 and is released at the opened end of the air guiding link 60. In addition, when the air from different water permeating elements 30 is released through the opened end of the air guiding link 60, another air stopper is coupled to the opened end of the air guiding link 60. Therefore, two ends of the air guiding link 60 will be the closed ends to prevent any air entering back therein.

Since two or more water guiding links 50 can be coupled together end-to-end for extending the water supplying distance, two or more air guiding links 60 can also be coupled together end-to-end for extending the air releasing distance. Accordingly, the opened end of the first air guiding link 60 can be exposed to the ambient area while the closed end of the first air guiding link 60 is opened by detaching the air stopper thereat to operatively couple with the opened end of the second air guiding link 60. Therefore, the air will be released from the water permeating elements 30 to the first and second air guiding links 60 via the air venting ducts 40.

Further, multiple above automate water permeating arrangements can be incorporated with each other in order to form an automate water permeating system for watering multiple above plant containers, wherein the automate water permeating system comprises at least a water reservoir 20, a plurality of water permeating elements 30, a plurality of air venting ducts 40, and a plurality of air guiding links 60. Each of the plant containers is corresponding to at least a water reservoir 20, at least a water permeating element 30 and at least an air venting duct 40. One end of the flexible water tube 31 of the water permeating element 30 corresponding to a pot body 10 is provided at a water reservoir 20 and extended from the water reservoir 20 to the pot cavity 11 of the pot body 10. Another end of the flexible water tube 31 of the water permeating element 30 is coupled with a water permeating head 32 and the water permeating head 32 is selectively submerged into the particular area of the pot cavity 11. Each of the air venting ducts 40 corresponding to the pot body 10 is respectively provided at the flexible water tube 31 of the water permeating element 30 as above, wherein one end of the air venting duct 40 is provided at a position of the flexible water tube 31, which is adjacent to the water permeating head 32 of the water permeating element 30, while the air venting duct 40 is upwardly extended from the flexible water tube 31 to the air guiding link 60.

It is worth mentioning that each of the water reservoirs 20 of the automate water permeating system comprises an inlet water pipe provided at the top portion of the water reservoir 20 and a venting member provided at the top portion of the water reservoir 20. The venting member of the previous water reservoir 20, which is nearer to the external water resource, is communicatedly coupled with the inlet water pipe of the next water reservoir 20 which is more far away from the water external water resource, such that the water from the external water resource may flow from the venting member of the previous water reservoir 20 to the next water reservoir 20 via the inlet water pipe thereof. So that when a user adds the water from the external water resource to the automate water permeating system and the previous water reservoir 20 is filled with the water, all the water reservoirs 20 of the automate water permeating system can be filled with water.

Preferably, the water reservoir 20 of the automate water permeating system, which is nearest to the external water resource, is adapted for guiding the water from the external water resource flowing to the water reservoir 20 which is nearest to the external water resource. The water from the external water resource may flow to the water reservoir 20 which is more far away from the external water resource via the inlet water pipe provided at the bladder cover of the water reservoir 20. The venting member provided at the bladder cover is adapted for venting air of the water bladder 21 and the venting member is communicatedly coupled with the inlet water pipe of the water bladder 21 of the next water reservoir 20 which is more far away from the water external water resource such that, when a user adds the water from the external water resource to the automate water permeating system and the previous water reservoir 20 is filled with water, the water from the external water resource will flow from the water bladder 21 of the previous water reservoir 20 to the water bladder 21 of the next water reservoir 20. Therefore, all of the water bladders 21 of the water reservoirs 20 of the automate water permeating system can be filled with water.

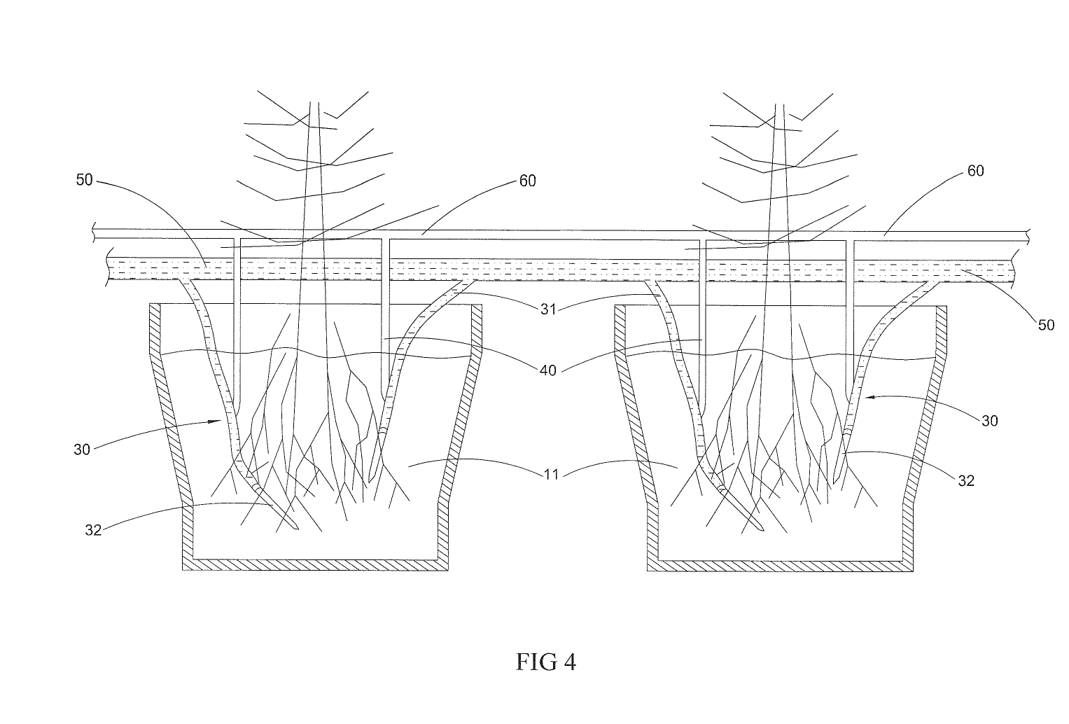

Alternatively, as shown in FIG. 4, the automate water permeating system comprises a water guiding link 50, a plurality of water permeating elements 30, a plurality of air venting ducts 40, and an air guiding link 60, wherein the water guiding link 50 is adapted for guiding the water from the external water resource to flow to the plant containers and reserving an amount of water. Each of the plant containers is corresponding to at least a water permeating element 30 and at least an air venting duct 40 is corresponding to the water permeating element 30. The flexible water tube 31 of each of the water permeating elements 30 is provided at the water guiding link 50 and adapted for guiding the water from the water guiding link 50 flowing to the pot cavity 11 of the pot body 10. The water permeating head 32 of each of the water permeating elements 30 is adapted for permeating the water from the flexible water tube 31 into a particular area of the pot cavity 11 of the pot body 10. The flexible water tube 31 of each of the water permeating elements 30 is communicatedly coupled with at least an air venting duct 40 and each of the air venting ducts 40 is respectively provided at the flexible water tube 31 of a water permeating element 30. One end of the air venting duct 40 is coupled with the flexible water tube 31 at a position adjacent to the water permeating head 32 of the water permeating element 30, and the air venting duct 40 is upwardly extended from the flexible water tube 31 of the water permeating element 30 to the air guiding link 60.

Alternatively, each of the water permeating elements 30 is made of water permeating fibers, such as cotton fibers, and one end of each of the water permeating elements 30 is communicatedly provided within a water outlet 212 of the water bladder 21 of the water reservoir 20 for guiding the water therein flowing to the soil of the pot cavity 11 of the pot body 10. The automate water permeating arrangement further comprises a plurality of water flow controls provided at the upper ends of the water permeating elements 30 respectively for adjusting the rate of flow flowing through the water permeating elements 30 as required.

Furthermore, the watering supplied by the automate water permeating arrangement of the present invention is a slow release watering for the plant or plants cultivated in the pot cavity 11 of the pot body 10 via the water permeating head of each of the water permeating elements 30. It is worth mentioning that the conventional irrigation for a plant container, for example an irrigation by a flower pot or other irrigation tools, is an irrigation that the water from the external water resource is directly added to the soil in plant containers or is directly guided to the soil of the plant container by a guiding water pipe, while the automate water permeating arrangement of the present invention comprises two parts for watering. One of the two parts of the present invention is the water reservoir 20 for storing the water. Another part is for guiding the water flow and permeating to the soil of the plant container. The water permeating head 32 of each of the water permeating elements 30 is made of water permeating material so that the water from the water reservoir 20 can slowly permeate from the water permeating head 32 of each of the water permeating elements 30. So the automate water permeating arrangement of the present invention may supply a slow release watering to a plant container, for example a conventional pot. When a user employs the same amount of water for a plant container, the automate water permeating arrangement of the present invention can significantly prolong the watering period of the plant container comparing to the conventional methods of watering such that the plant container can be supplied corrected amount of water to maintain and control a moisture level of the soil of the plant container and prevent overwatering the soil of the plant container.

Preferably, the pot body 10 incorporated with the automate water permeating arrangement of the present invention further has a drain outlet provided in the bottom portion thereof, wherein when the pot is overwatered, the excess water can be drained via the drain outlet.

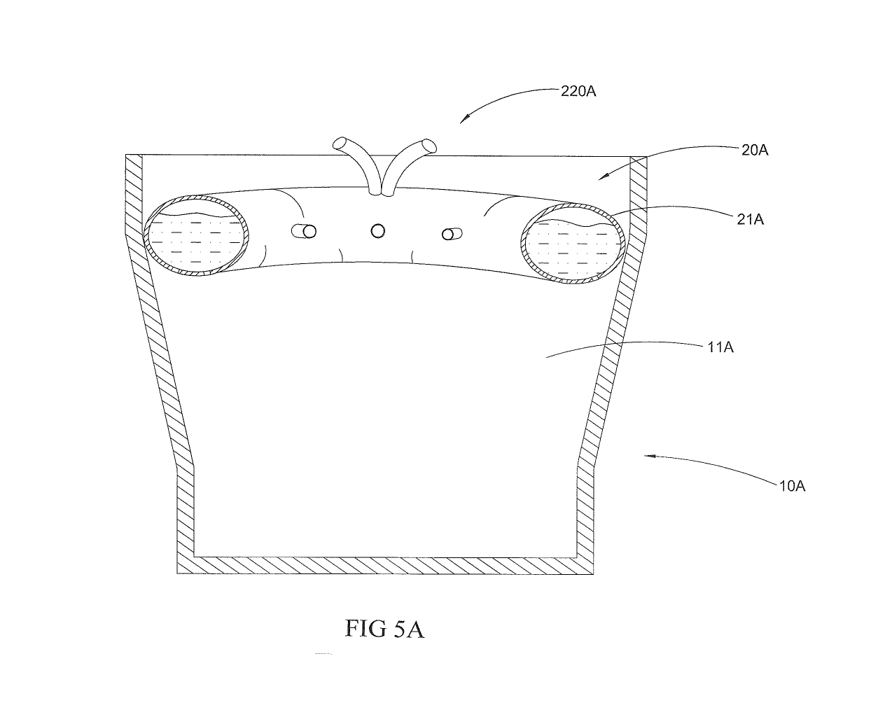

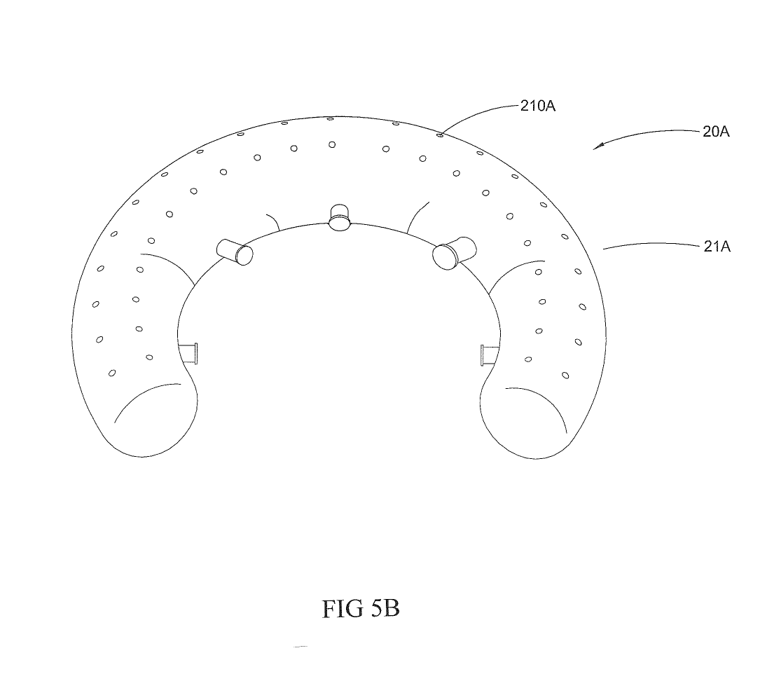

Referring to FIGS. 5A and 5B of the drawings, an automate water permeating arrangement for one or more plant containers 10A according to a second preferred embodiment of the present invention is illustrated, wherein the plant container 10A is a conventional plant pot in which flowers and other plants are cultivated. In particular, the roots of the plant are firmly disposed in the plant container by soil.

The plant container 10A, for example the plant pot 10A, has a pot cavity 11A for containing the soil and the root of the plant and a rim 12A defining a top opening of the pot cavity 11A to allow the plant to grow. Accordingly, the roots of the plant are retained within the pot cavity 11 of the pot body 10A by the soil.

The automate water permeating arrangement comprises a water reservoir 20A which is arranged for reserving a predetermined amount of water. The water reservoir 20A comprises a water bladder 21A, preferably having a C-shape. The bottom of the water bladder 21A has a higher elevation than the surface of the top portion of the soil of the pot cavity 11A such that the water of the water bladder 21A of the water reservoir 20A can be guided to permeate from the water bladder 21A and drip to the soil of the pot cavity 11A of the pot body 10A by the gravity force via a plurality of water permeating pores 210A provided in the bottom portion of the water bladder 21A.

It is worth mentioning that the water bladder 21A has a shape as the user desired, for example C-shape, D-shape, O-shape or the like, preferably C-shape. The water bladder 21A further comprises a plurality of water bladder units, wherein the plurality of water bladder units is communicatedly connected with each other in order to form the water bladder 21A. Each of the water bladder units of the water bladder 21A may be a separated mini-water bladder and each of the water bladder units of the water bladder 21 A comprises a plurality of water permeating pores 210A provided in the bottom portion thereof to guide the water of the water bladder unit dripping to the soil of the pot cavity 11A.

It is appreciated that the water bladder 21A is preferably provided above the top portion of the soil of the pot cavity 11A of the pot body 10A such that the user do not require removing any part of the plant container and any special tool for automatically dripping the water to the soil of the pot cavity 11A.

The water bladder 21A further comprises a water inlet 200A provided at the top portion thereof for filling the water bladder 21 A with the water from the external water resource. Accordingly, the user can also fill up the water in the water bladder 21A, for example by a water container such as water bottle. It is worth mentioning that nourishing liquid can also be added into the water bladder 21A such that the nourishing liquid will be transported to the soil by means of the automate water permeating arrangement.

Alternatively, the water bladder 21A is made of soft material having flexibility, wherein when the water bladder 21A has no water therein, the water bladder 21A is at a folded position. At this time, the water bladder 21A has no air or only a little of air therein. When the water bladder 21A is waterflooded through the water inlet 200A of the water bladder 21A, the water bladder 21A is continuously expanded by the water from the water resource. When the water bladder 21A is full of water, the water bladder 21A is at an unfolded position.

Alternatively, the water bladder 21A is made of rigid material, and the water bladder 21A has a relatively bigger water inlet 200A provided in the top portion thereof. When the water bladder 21A is waterflooded through the water inlet 200A of the water bladder 21A and if the cross-section of the water flow from the water resource is smaller than the cross-section of the water inlet 200A of the water bladder 21A, the air of the water bladder 21A will be exhausted through the water inlet 200A. Preferably, the water bladder 21A comprises an inlet cover for covering the water inlet 200A, wherein the inlet cover has an inlet opening and an outlet opening that, the inlet opening is adapted for guiding the water from the water resource flow to the water bladder 21A and the outlet opening is adapted for venting the air of the water bladder 21A. More preferably, the water permeating arrangement comprises an inlet water pipe provided at the bladder cover for communicatedly connecting to the water bladder 21A and an air venting duct provided at the bladder cover for venting the air of the water bladder 21A.

The automate water permeating arrangement further comprises a plurality of water flow control, corresponding to the plurality of water permeating pores 210A respectively, which is provided at the bottom of the water bladder 21A for adjusting the rate of water flow flowing through the water permeating pores 210A as required,.

It is worth mentioning that each of the water permeating pores 210A has a diameter of 0.01 mm˜30 mm, preferably 0.1 mm˜1 mm.

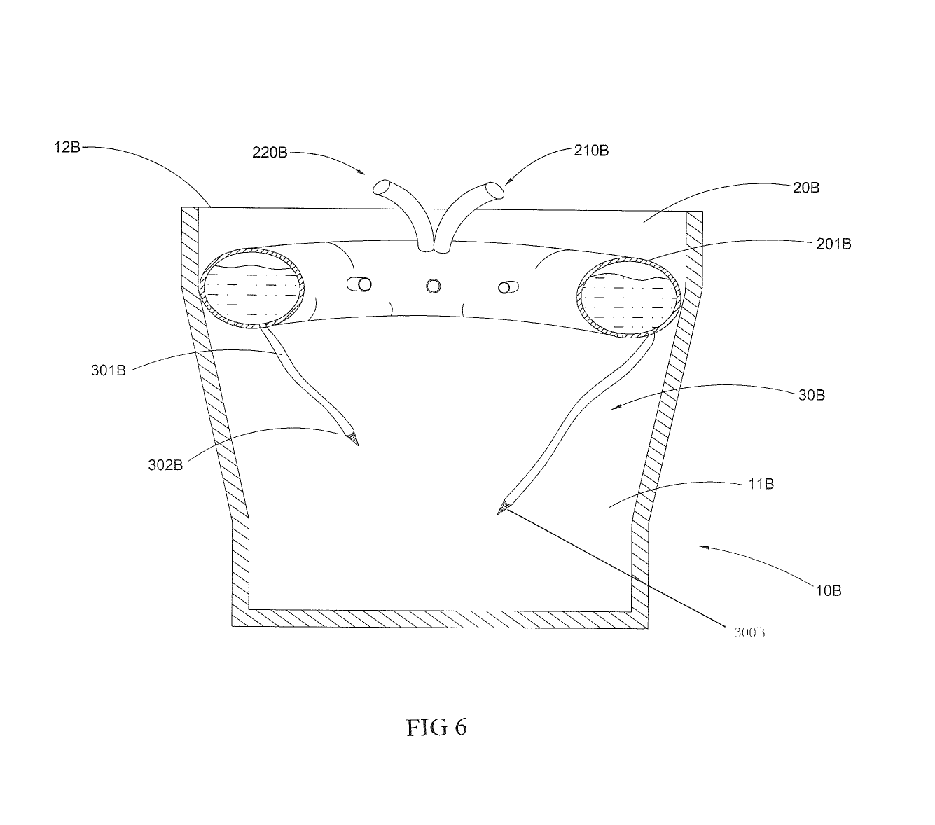

Referring to FIG. 6 of the drawings, an automate water permeating arrangement for one or more plant containers 10B according to a third preferred embodiment of the present invention is illustrated, wherein the plant container 10B is a conventional plant pot in which flowers and other plants are cultivated. In particular, the roots of the plant are firmly held within the plant container by soil.

The plant container 10B, for example the plant pot 10B, has a pot cavity 11B for containing the soil and the root of the plant and a rim 12B defining a top opening of the pot cavity 11B to allow the plant to grow. Accordingly, the roots of the plant are retained within the pot cavity 11B of the pot body 10B by the soil.

The automate water permeating arrangement comprises a water reservoir 20B arranged for reserving a predetermined amount of water, and a plurality of water permeating elements 30B. Each of the water permeating elements 30B comprises a water guiding end 301B extended from the water reservoir 20B and a water permeating end 302B being selectively submerged into a particular area of the pot cavity 11B.

Accordingly, the water permeating elements 30B are adapted for guiding the water from the water reservoir 20B to the particular areas of the pot cavity 11B and for gradually permeating the water at the water permeating ends 302B of the water permeating elements 30B so as to maintain and control a moisture level of the soil. In other words, the water permeating ends 302B of the water permeating elements 30B are respectively located at different areas of the pot cavity 11B to permeate the water thereinto so as to evenly supply water at all areas of the pot cavity 11B to the roots of the plant.

The water reservoir 20B comprises a water bladder 21B, preferably having a C-shape, disposed on the top surface level of the soil within the pot cavity 11B, such that the water within the water reservoir 20B is guided to flow to the water permeating elements 30B by means of water pressure.

It is worth mentioning that the water bladder 21B has a shape as desired, for example C-shape, D-shape, O-shape or the like, preferably C-shape. The water bladder 21B further comprises a plurality of water bladder units, wherein the plurality of water bladder units is communicatedly connected with each other in order to form the water bladder 21B. Each of the water bladder units of the water bladder 21B may be a separated mini-water bladder respectively such that each of the water bladder units is communicatedly coupled with one or more water permeating elements 30B to guide the water of the water bladder units of the water bladder 21B to flow into the soil of the pot cavity 11B.

The water bladder 21B has a water inlet 200B adapted for filling the water bladder 21B with the water from the external water resource, wherein the water guiding ends 301B of the water permeating elements 30B are spacedly extended from the inner surface of the water bladder 21B to the pot cavity 11B, such that one of the terminal portions of each of the water guiding ends 301B is hidden within the water bladder 21B.

The water bladder 21B is preferably provided above the top portion of the soil of the pot cavity 11B of the pot body 10B such that the user does not require removing any part of the plant container and any special tool for automatically watering the water to the soil of the pot cavity 11B. The user can also fill up the water in the water bladder 21B, for example by a water container such as water bottle. It is worth mentioning that nourishing liquid can also be added into the water bladder 21B such that the nourishing liquid will be transported to the soil via the water permeating elements 30B.

The water reservoir 20B further has a plurality of water outlets 210B defined in the wall of the water bladder 21B for guiding the water from the water bladder 21B flowing into each of the water guiding ends 301B of the water permeating elements 30B which is communicatedly connected to the water bladder 21B. In particular, the water guiding ends 301B of the water permeating elements 30B are detachablely and communicatedly coupled with the water outlets 210B of the water bladder 21B respectively. In other words, the water permeating end 302B of each of the water permeating elements 30B is hidden within the pot cavity 11B and protected by the pot body 10B. When a bigger plant container 10B or plant needs a relatively larger amount of water, a greater number of water permeating elements 30B can be used for coupling with the water bladder 21B and guiding the water from the water bladder 21B flow to the pot cavity 11B. It is worth mentioning that unused water outlets 210B can be blocked to prevent water leakage from the water bladder 21B. Preferably, a sealing ring is provided around the outer circumferential surface of the position where the water guiding end 301B of the water permeating element 30B is provided for coupling with the water bladder 21B of the water reservoir 20B to sealedly couple one end of the water guiding end 301B of the water permeating element 30B in the water outlet 210B for preventing water leakage.

Alternatively, the water bladder 21B is made of soft material having flexibility, when the water bladder 21B has no water therein, the water bladder 21B is at a folded position. When the water bladder 21B is waterflooded through the water inlet 200B of the water bladder 21B, the water bladder 21B is continuously expanded by the water from the water resource. When the water bladder 21B is full of water, the water bladder 21B is at an unfolded position.

Alternatively, the water bladder 21B is made of rigid material, and the water bladder 21B has a relatively bigger water inlet 200B provided in the top portion thereof.

When the water bladder 21B is waterflooded through the water inlet 200B of the water bladder 21B and if the cross-section of the water flow from the water resource is smaller than the cross-section of the water inlet 200B of the water bladder 21B, the air of the water bladder 21B will be exhausted through the water inlet 200B. Preferably, the water bladder 21B comprises an inlet cover for covering the water inlet 200B, wherein the inlet cover has an inlet opening and an outlet opening. The inlet opening is adapted for guiding the water from the water resource to flow to the water bladder 21B, and the outlet opening is adapted for venting the air of the water bladder 21B. More preferably, the water permeating arrangement comprises an inlet water pipe provided at the bladder cover for communicatedly connecting to the water bladder 21B and an air venting duct provided at the bladder cover for venting the air of the water bladder 21B.

It is worth mentioning that the water permeating element 30B has a hollow and tubular structure, wherein one end of the water permeating end 302B of the water permeating element 30B is communicatedly coupled with the water guiding end 301B, and another end of the water permeating end 302B is closed. The water permeating element 30B has a plurality of water permeating pores 300B provided at the closed end of the water permeating end 302B for guiding the water from the water permeating end 302B to permeate to the soil around the closed end of the water permeating end 302B so as to maintain and control the moisture level of the soil.

The automate water permeating arrangement according to the third preferred embodiment of the present invention further comprises a plurality of water flow controls provided at the upper ends of the water guiding ends 301B of the water permeating elements 30B respectively for adjusting the rate of water flow flowing through the water permeating element 30B as required, so as to maintain and control the moisture level of the soil.

It is worth mentioning that each of the water permeating pores 300B has a diameter of 0.01 mm˜30 mm, preferably 0.1 mm˜1 mm.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An automate water permeating arrangement for a plant container, comprising:
a water reservoir which is adapted for reserving a predetermined amount of water; and
a plurality of water permeating elements, each of said water permeating elements having a water guiding end extended from said water reservoir and a water permeating end being selectively submerged into a particular area of a pot cavity of said plant container under a top surface level of a soil, wherein said water permeating elements are adapted for guiding said water from said water reservoir to said particular areas of said pot cavity and for gradually permeating said water at said water permeating ends of said water permeating elements so as to maintain and control a moisture level of said soil.

2. The automate water permeating arrangement, as recited in claim 1, wherein each of said water permeating elements comprises a flexible water tube defining said water guiding end thereat to extend from said water reservoir, and a water permeating head defining said water permeating end thereof being selectively submerged into said pot cavity for gradually permeating said water to said soil.

3. The automate water permeating arrangement, as recited in claim 2 wherein said flexible water tube is extended to said water permeating head end-to-end that said flexible water tube provides a predetermined flexibility to be adjustably turned to selectively locate said water permeating head at said particular area of said pot cavity.

4. The automate water permeating arrangement, as recited in claim 2, wherein said water permeating head has a plurality of water permeating pores and is arranged in such a manner that when a water content of said water permeating head is lower than a water content of said soil, said water permeating head is arranged for gradually permeating said water to said soil through said water permeating pores and when said water content of said water permeating head is higher than a water content of said soil, said water permeating head is arranged for stop permeating said water into said soil.

5. The automate water permeating arrangement, as recited in claim 3, wherein said water permeating head has a plurality of water permeating pores and is arranged in such a manner that when a water content of said water permeating head is lower than a water content of said soil, said water permeating head is arranged for gradually permeating said water to said soil through said water permeating pores and when said water content of said water permeating head is higher than a water content of said soil, said water permeating head is arranged for stop permeating said water into said soil.

6. The automate water permeating arrangement, as recited in claim 2, further comprising a plurality of air venting ducts operatively coupled with said flexible water tubes respectively for releasing air within said flexible water tubes when said water is guided to said water permeating heads.

7. The automate water permeating arrangement, as recited in claim 5, further comprising a plurality of air venting ducts operatively coupled with said flexible water tubes respectively for releasing air within said flexible water tubes when said water is guided to said water permeating heads.

8. The automate water permeating arrangement, as recited in claim 6, wherein each of said air venting ducts has a lower end coupled with said respective flexible water tube at a position close to said water permeating head, and an upper end extended upwardly above said top surface level of said soil.

9. The automate water permeating arrangement, as recited in claim 7, wherein each of said air venting ducts has a lower end coupled with said respective flexible water tube at a position close to said water permeating head, and an upper end extended upwardly above said top surface level of said soil.

10. The automate water permeating arrangement, as recited in claim 1, wherein said water reservoir comprises a water bladder, which is adapted for being placed on said top surface level of said soil, having a water inlet adapted for being filled said water in said water bladder, wherein said water guiding ends of said water permeating elements are spacedly extended from an inner wall of said water bladder.

11. The automate water permeating arrangement, as recited in claim 5, wherein said water reservoir comprises a water bladder, which is adapted for being placed on said top surface level of said soil, having a water inlet adapted for being filled said water in said water bladder, wherein said water guiding ends of said water permeating elements are spacedly extended from an inner wall of said water bladder.

12. The automate water permeating arrangement, as recited in claim 9, wherein said water reservoir comprises a water bladder, which is adapted for being placed on said top surface level of said soil, having a water inlet adapted for being filled said water in said water bladder, wherein said water guiding ends of said water permeating elements are spacedly extended from an inner wall of said water bladder.

13. An automate water permeating arrangement for two or more plant containers, comprising:
a water reservoir which is adapted for reserving a predetermined amount of water; and
a plurality of water permeating elements for guiding said water to said plant containers respectively, each of said water permeating elements having a water guiding end operatively linked from said water reservoir and a water permeating end being selectively submerged into a particular area of a pot cavity of said respective plant container under a top surface level of a soil, wherein each of said water permeating elements is adapted for guiding said water from said water reservoir to said particular area of said pot cavity and for gradually permeating said water at said water permeating end of said water permeating element so as to maintain and control a moisture level of said soil.

14. The automate water permeating arrangement, as recited in claim 13, wherein each of said water permeating elements comprises a flexible water tube defining said water guiding end thereat to extend from said water reservoir, and a water permeating head defining said water permeating end thereof being selectively submerged into said pot cavity for gradually permeating said water to said soil.

15. The automate water permeating arrangement, as recited in claim 14 wherein said flexible water tube is extended to said water permeating head end-to-end that said flexible water tube provides a predetermined flexibility to be adjustably turned to selectively locate said water permeating head at said particular area of said pot cavity.

16. The automate water permeating arrangement, as recited in claim 15, wherein said water permeating head has a plurality of water permeating pores and is arranged in such a manner that when a water content of said water permeating head is lower than a water content of said soil, said water permeating head is arranged for gradually permeating said water to said soil through said water permeating pores and when said water content of said water permeating head is higher than a water content of said soil, said water permeating head is arranged for stop permeating said water into said soil.

17. The automate water permeating arrangement, as recited in claim 16, further comprising a flexible water guiding link having a closed end and an opened end extended from said water reservoir, wherein said water guiding ends of said water permeating elements are spacedly extended from said water guiding link between said closed and opened ends for guiding said water from said water reservoir to said water permeating elements through said water guiding link.

18. The automate water permeating arrangement, as recited in claim 14, further comprising a plurality of air venting ducts operatively coupled with said flexible water tubes respectively for releasing air within said flexible water tubes when said water is guided to said water permeating heads.

19. The automate water permeating arrangement, as recited in claim 17, further comprising a plurality of air venting ducts operatively coupled with said flexible water tubes respectively for releasing air within said flexible water tubes when said water is guided to said water permeating heads.

20. The automate water permeating arrangement, as recited in claim 18, further comprising an air guiding link, wherein each of said air venting ducts has a lower end coupled with said respective flexible water tube at a position close to said water permeating head, and an upper end extended upwardly to said air guiding link such that said air within said flexible water tubes is collected by said air guiding link.

21. The automate water permeating arrangement, as recited in claim 19, wherein said air guiding link has an opened end and a closed end that said upper ends of said air venting ducts are extended between said opened and closed ends, such that said air collected within said air guiding link is released at said opened end thereof.

22. The automate water permeating arrangement, as recited in claim 20, wherein said air guiding link has an opened end and a closed end that said upper ends of said air venting ducts are extended between said opened and closed ends, such that said air collected within said air guiding link is released at said opened end thereof.

23. The automate water permeating arrangement, as recited in claim 13, wherein said water reservoir is positioned above said water guiding ends of said water permeating elements.

24. The automate water permeating arrangement, as recited in claim 22, wherein said water reservoir is positioned above said water guiding ends of said water permeating elements.
